(19) United States
(12) Patent Application Publication
(10) Pub. No.: US 2009/0193608 A1
(43) Pub. Date: Aug. 6, 2009

(54) DRIVE MECHANISM ESPECIALLY FOR A WINDOW WIPING DEVICE WITH AN ELLIPTICAL WIPING MOTION

(75) Inventor: Christophe Lassale, Leigne Les Bois (FR)

Correspondence Address: OSHA LIANG L.L.P., TWO HOUSTON CENTER, 909 FANNIN, SUITE 3500, HOUSTON, TX, 77010, US

(73) Assignee: VALEO SYSTEMES D'ESSUYAGE, Le Mesnil-Saint-Denis (FR)

(21) Appl. No.: 11/994,322

(22) PCT Filed: Jun. 14, 2006
(86) PCT No.: PCT/EP06/05731

§ 371 Date: Jul. 22, 2008

(30) Foreign Application Priority Data
Jun. 29, 2005 (FR) 0506636

(51) Int. Cl. B60S 1/34; B60S 1/58; B60S 1/26

(52) U.S. Cl. 15/250.23; 74/89.16

(57) ABSTRACT

The invention relates to a drive mechanism (30) especially for a window wiping device (1) with an elliptical wiping motion, said device comprising a primary actuating axle (20), a rotary support (40), a fixed toothed wheel (50), at least one central toothed wheel (60), an output toothed wheel (70), and a secondary actuating axle (50), the toothed wheels (50, 60, 70) being engaged with each other and forming a two-stage gear system. The invention is characterised in that the rotary support (40) comprises two supporting elements (41, 42) that respectively carry the two stages of the gear system, and in that the two supporting elements (41, 42) can be arranged in relation to each other following at least two separate angular positions in which the toothed wheels (50, 60, 70) are effectively engaged.

The present invention relates to a drive mechanism making it possible to transform an axial rotation motion into a wiping motion of the elliptical type, a wiping device including such mechanism and a motor vehicle including such a wiping device.

One particularly advantageous but not exclusive application of the invention is in the field of wiping devices for motor vehicles.

If the windscreens of the motor vehicles tend to become larger and larger at present, the back windows tend to have reduced dimensions in particular because of aesthetic and/or architectural constraints. Whatever the reasons, the wiping devices which are associated with this type of glass surfaces must be compatible with this evolution nowadays.

Now, the conventional wiping devices, i.e. the wiping devices having a circular wiping motion, are, in practice, particularly ill-suited to glasses with a width much greater than the height. Reference is made here to the back windows of modern motor vehicles. As a matter of fact, the smallest dimension of the glass conditions the length of the wiper which can be used. Thus, if the height of the glass is small, the wiping surface will be reduced and the cleaning will be carried only locally.

To remedy such disadvantage, it is known to use wiping devices having an elliptical wiping motion.

In this type of wiping devices, the displacement of the wiper arm following a path having substantially the shape of an ellipse is generally created by using a drive mechanism capable of transforming an axial rotation motion into an elliptical motion. Such a drive mechanism generally consists of a two-stage gear system which is mounted in a rotary support likely to be driven into alternate rotation by means of a fixed axle coupled to motor means, the output axle of the gear system supporting the wiper arm assembly of the wiping device.

In practice, the gear system is generally composed of three toothed wheels. One fixed toothed wheel which is not integral with the rotary support is positioned coaxially with respect to the input axle. A central toothed wheel is supported in axial rotation by the rotary support and engaged with the fixed wheel. Eventually, an output toothed wheel which is also supported in axial rotation by the rotary support, engages the central wheel and axially supports the output axle of the system.

Such type of wiping device having an elliptical wiping motion has the disadvantage of being particularly costly since the drive mechanism is generally specific to each application. As a matter of fact, it is the distance between the input axle and the output axle of the discussed mechanism which determines the ratio between the smaller and the bigger diameters of the elliptic path. Thus, when the dimensions of a back window are different from one vehicle to another, it is necessary to change the gear system to adapt the distance between the axles with a view to optimise the effective wiping surface. If the motor means, the wiper arm assembly and the wiping device can be standardised, this is not true for the intermediate drive mechanism which is important as regards costs in the end.

Thus, the technical problem to be solved by the object of the present invention consists in providing a drive mechanism, more particularly for a window wiping device specially having an elliptical wiping motion, comprising a primary actuating axle intended to be driven into alternate rotation, a rotary support integral with the primary drive axle, a fixed toothed wheel positioned coaxially with respect to the primary actuating axle, at least one central toothed wheel supported in axial rotation by the rotary support, an output toothed wheel supported in axial rotation by the rotary support and a secondary actuating axle made integral with the output wheel, the toothed wheels being engaged with each other and forming a two-stage gear system, the drive mechanism making it possible to prevent any problems on the state of the art by ensuring a substantially reduced manufacturing cost.

The solution to the technical problem, according to the present invention, consists in that the rotary support includes two supporting elements which respectively carry the two stages of the gear system and in that the two supporting elements can be arranged in relation to each other following at least two separate angular positions in which the toothed wheels are effectively engaged.

Thus, the drive mechanism has a variable geometry structure which makes it possible to change the relative position of the two elements composing the rotary support with a view to varying the angular positioning of the two-stage gear system and thus to modify the distance between the axis of the system.

A distance between the axles of a drive mechanism can also vary between two extreme values, i.e. a maximum value corresponding to the alignment of the axles of the three toothed wheels and a minimum value corresponding to a smaller distance between the two stages of the gear system and the positioning of the output wheel as close to the fixed wheel as possible.

The invention as defined herein has the advantage of being able to modify the kinematics of the elliptical wiping motion of a wiping device without having to change the toothed wheel nor the flanges of the rotary support. Thus, this makes it possible for the same wiping device to be able to be mounted on various vehicles. Such characteristic gives the wiping device according to the invention, a standardisation capacity which can substantially reduce its cost.

The invention also makes it possible to optimise the kinematics of the elliptical wiping motion. As a matter of fact, it is possible to precisely adapt the distance between the axles to the effective dimensions of the surface to be wiped and to more particularly adopt the optimal theoretical value making it possible to obtain a maximum wiping surface.

Another characteristic of the invention consists in the fact that the drive mechanism is designed in a unique way, the calculations of mechanical behaviour and kinematics dimensions are made only once, even though the mechanism is liable to be used in a plurality of various applications as a function of the selected value of the distance between axles.

The present invention also relates to a wiping device having an elliptical wiping motion including motor means capable of generating an alternate rotation motion, as well as a wiper arm assembly at the end of which a wiping arm is mounted, characterised in that it further includes a drive mechanism and in that the motor means are coupled to the primary actuating axle and that the wiper arm is integral with the secondary actuating axle.

The present invention also relates to the characteristics which will be mentioned in the following description and which will be considered separately or in any possible technical combinations.

Such description, which is given as a non-limitative example is intended to be better understand what the invention is and how it can be embodied. Besides, it is given while referring to the appended drawings in which:

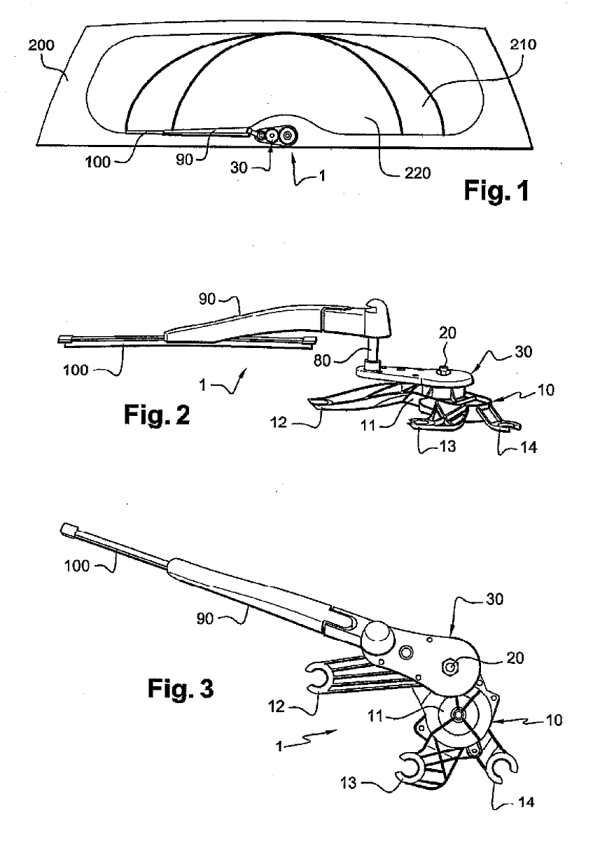

FIG. 1 shows a back window of a motor vehicle which is provided with a wiping device having an elliptic wiping motion, incorporating a drive mechanism according to the invention.

FIG. 2 is a side perspective view showing only the wiping device of FIG. 1.

FIG. 3 is a view similar to FIG. 2 but it is a top perspective view.

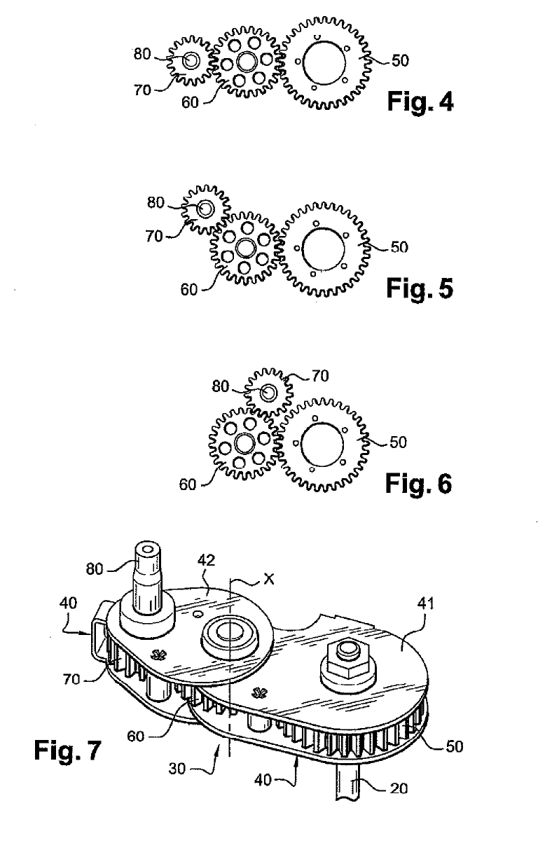

FIG. 4 shows the gear system of the drive mechanism provided on the wiping device of FIG. 1 to 3, the three toothed wheels being positioned with a maximum distance between axles.

FIG. 5 is a view similar to FIG. 4 but with the three toothed wheels of the gear system positioned with a reduced distance between axles.

FIG. 6 is a view similar to FIGS. 4 and 5 but with the three toothed wheels positioned with a minimum distance between axles.

FIG. 7 shows in perspective a first exemplary drive mechanism wherein the angular positioning of the supporting elements makes it possible to position with three toothed wheels as per FIG. 4.

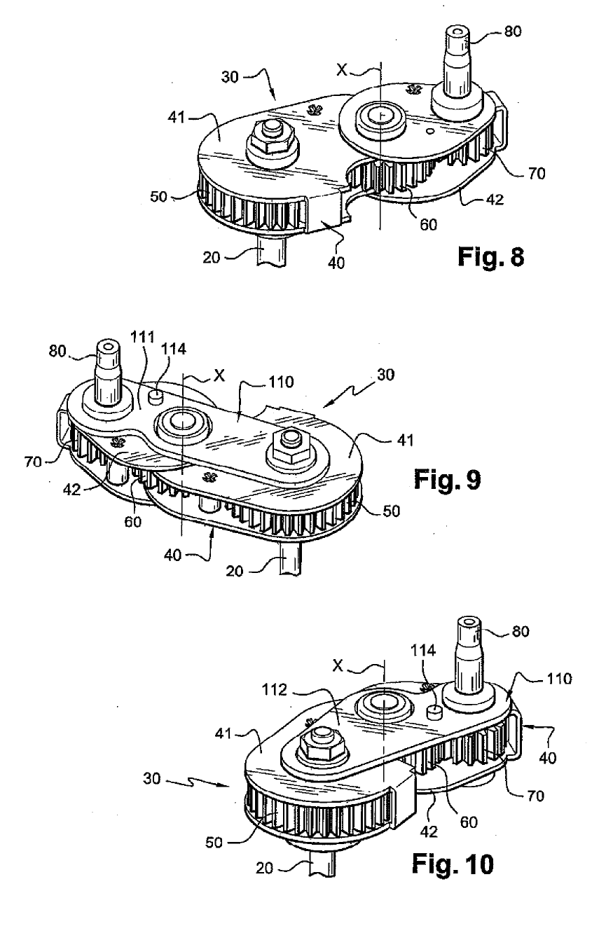

FIG. 8 is a view similar to FIG. 7, but according to an opposite perspective.

FIG. 9 shows the drive mechanism of FIG. 7 and 8 but with the supporting elements being locked by locking means.

FIG. 10 illustrates in perspective a second example of the drive mechanism in which the angular positioning of the supporting elements makes it possible to position the three toothed wheels as per FIG. 5 and wherein the supporting elements are locked by locking means.

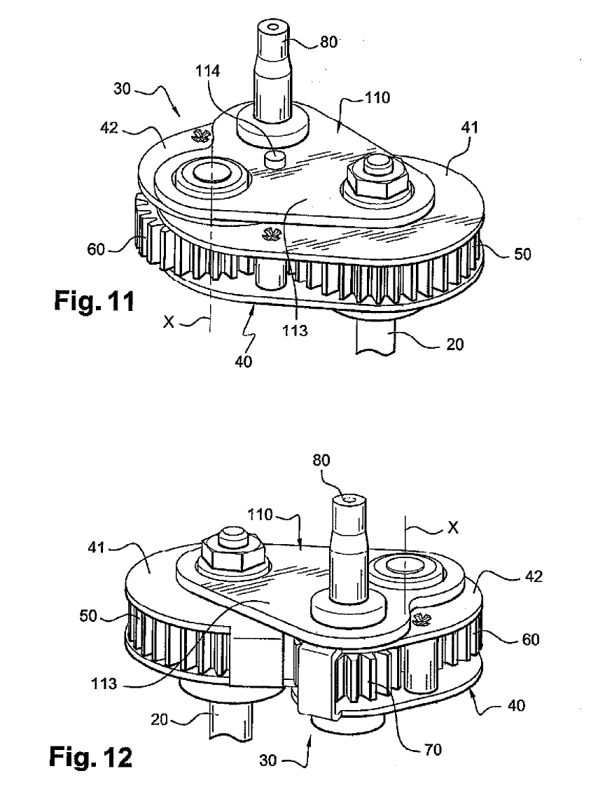

FIG. 11 shows in perspective a third example of drive mechanism, wherein the angular positioning on the supporting element makes it possible to position the three toothed wheels as per FIG. 6 and wherein the supporting elements are locked by locking means.

FIG. 12 is a view similar to FIG. 11 but according to an opposite perspective.

For purposes of clarity, the same elements have been indicated by identical reference numbers. Similarly, only the essential elements for understanding the invention have been shown without respecting the scale and in a schematic way.

FIG. 1 shows a back window 200 of a motor vehicle, at the lower part of which a wiping device having an elliptical wiping motion 1 is mounted and integrates a drive mechanism 30 according to the invention. It should be noted that this case is a truly typical example of the application for an elliptical wiping kinematics, in that the very low height of the back window 200 with respect to its width makes any kinematics of circular wiping inappropriate.

In order to illustrate the value of the elliptical kinematics in this case, the wiping surfaces 210, 220 which respectively result from two kinds of wiping motions, are shown together on a back window 200 visible in FIG. 1. The dimensional superiority of the elliptical surface 210 with respect to the circular surface 220 is evident. And the extension of the wiping blade 100 in the fixed stop and opposite fixed stop positions, by contrast with the wiping height in the central part, can also be noted.

As per FIGS. 1 to 3, in this exemplary embodiment selected as an example only, the wiping device 1 is first provided with motor means 10 which are liable to create an alternate rotation motion. Such motor means 10 include a motor reducer 11, the protective housings of which integrate anchoring lugs 12, 13, 14 which are similar to that of a supporting plate.

The wiping device 1 is also provided with a primary actuating axle 20 which is intended to be driven into alternate rotation. The primary actuating axle 20 is composed of the output axle of the motor reducer 11.

The wiping device 1 further includes a drive mechanism 30 which is liable to generate an elliptical motion combined with the rotation of the primary actuating axle 20.

As shown in the other FIGS. 4 to 12, such drive mechanism 30 first includes a rotary support 40 which is integral with the primary actuating axle 20. But the drive mechanism 30 further includes a fixed toothed wheel 50 which is positioned in a coaxial way with respect with to the primary actuating axle 20. The drive mechanism 30 is then provided with a central toothed wheel 60 which is supported in axial rotation by the rotary support 40 and which is engaged with the fixed wheel 50. Eventually, the drive mechanism 30 is provided with an output toothed wheel 70 which is supported in axial rotation by the rotary support 40 and which is engaged with the central wheel 60. The assembly is so arranged that the three toothed wheels 50, 60, 70 form a two-stage gear system.

The wiping device I further includes a secondary actuating axle 80 which is made integral with the output wheel 70, so that it can be driven into rotation by the drive mechanism 30.

The exemplary embodiment shown provides for only one central wheel 60. However, several central wheels 60 can be provided depending on the distance desired between the respectively primary 20 and secondary 80 actuating axles.

The wiping device 1 further includes a wiper arm assembly 90 which is made integral with the secondary actuating axle 80 and which is a standard component, here.

The wiping device 1 is eventually provided with a wiping arm 100 which is mounted at the end of the wiper arm assembly 90 and which is also a standard component.

According to the object of the present invention and as can be seen in FIGS. 7 to 12, the rotary support 40 includes two supporting elements 41, 42, one of which 41 carries a stage of the gear system and the other one 42 carries the remaining wheel 70 in the gear system. The assembly is configured so that the two supporting elements 41, 42 can be positioned in relation to each other along two separate angular positions in which the three toothed wheel 50, 60, 70 are effectively engaged.

According to a particular characteristic of such embodiment, the two supporting elements 41, 42 are mounted to pivot with respect to each other along an axis collinear with the rotation axis X of the central wheel 60. Besides, the wiping device 1 is further provided with locking means 110 which can lock the relative pivoting between the supporting elements 41, 42.

According to another characteristic of such embodiment which can be seen in FIGS. 9 to 12, the locking means 110 include at least one locking element 111, 112, 113 which is able, on the one hand, to get engaged with at least one portion substantially complementary to at least one of the two supporting elements 41, 42 along a direction which is substantially parallel to the pivoting axis X of said supporting elements 41, 42 and on the other hand to be made integral with at least one of the two supporting elements 41, 42.

It should be noted that in the case when a locking element 111, 112, 113, on the one hand, is engaged with only one of the two supporting elements 41, 42 and on the other hand, is fixed to only one of said supporting elements 41, 42, the engagement and the locking must function respectively on each of the two supporting elements 41, 42 separately.

It is well understood that the integration of each locking element 111, 112, 113 can be made by any known fixing technique such as for example screwing and/or riveting and/or clamping and/or heading and/or welding and/or gluing.

In an alternative of the embodiment (not shown), the two supporting elements 41, 42 are movable with respect to each other and the wiping device includes fixing means liable to combine said supporting elements together. Of course, the assembly is so arranged that the three toothed wheels 50, 60, 70 are always engaged since the supporting elements 41, 42 are combined together by the fixing means.

In this case, the two supporting elements 41, 42 are structurally independent from each other. But they have the capacity of being coupled together along at least two separate angular positions so that the three toothed wheels 50, 60, 70 are engaged effectively.

Similarly to what has just been mentioned, the fixing means can be of any known type since the combination can be obtained, in particular, by screwing and/or riveting and/or clamping and/or heading and/or welding and/or gluing. Besides, it should be noted that each fixing operation performed can be reversible or not.

According to a particular characteristic of such alternative embodiment, the fixing means are provided with at least one connection element which is liable to be made integral with the two supporting elements 41, 42.

Such characteristic means that the combination between the two supporting elements 41, 42 is not necessarily direct, but it can be indirectly obtained using at least an intermediate part, i.e. a connecting element.

According to another special characteristic of this alternative embodiment, at least one connecting element is liable to engage with at least one portion substantially complementary to at least one of the two supporting elements 41, 42 along a direction which is substantially parallel to the pivoting axis X of said supporting elements 41, 42.

This characteristic makes it possible to facilitate a correct angular positioning between the two supporting elements 41, 42, with the engagement obtained being some kind of pre-positioning.

According to another characteristic of the invention, the wiping device is provided with adjusting means which are liable to precisely position the two supporting elements 41, 42 in relation to each other along at least two separate angular positions in which the three toothed wheel 50, 60, 70 are effectively engaged.

It should be noted that the function of the adjusting means can be more particularly ensured by the locking means and/or the fixing means depending on the supporting elements 41, 42 being respectively pivoting or movable in relation to each other.

According to another characteristic of the invention, the rotary support 40 forms a casing around the toothed wheels 50, 60, 70 of the gear system. It can be noted in addition that it is possible to make a case having both functions of protection and tightness.

FIGS. 7 to 9, more particularly, show the drive mechanism 30 in a position making it possible to take advantage of the maximum distance between axles, the axis of the three toothed wheels 50, 60, 70 being then in perfect alignment as per FIG. 4. The locking means 110 which are in charge of locking the supporting elements 41, 42 in a position which is substantially linear, are made of a single locking element 111. The latter is engaged around three embossed portions which are respectively provided concentrically around the axles of the toothed wheels 50, 60, 70 and in addition, it is engaged only with the supporting element 42 using a rivet 114.

The drive mechanism 30 in FIG. 10 takes advantage of a geometry which makes it possible to have a reduced distance between axles, with the axes on the three toothed wheels 50, 60, 70 then being slightly shifted as per FIG. 5. The locking means 110 are always made of a single locking element 112 which, as the one shown in FIGS. 7 to 9, is engaged around the three embossed portions mentioned above, and it is fixed only to the supporting element 42 by means of a rivet 114.

The drive mechanism 30 which can be seen in FIGS. 11 and 12 is remarkable in that it has a geometry which makes it possible to have a minimum distance between axles, with the axes of the three toothed wheels 50, 60, 70 being grouped as per FIG. 6. The locking means 110 are here only one locking element 113 which is engaged around the three embossed portions of the supporting elements 41, 42 which is also fixed to only one supporting element 42 using a rivet 114.

Of course, the invention also applies to any motor vehicle provided with at least one wiping device having an elliptical wiping motion 1, such as disclosed hereabove.

It should also be noted that although the selected example of application applies to a back window, the invention can be used for any glass surface in a motor vehicle and in particular the windscreen.

1. A drive mechanism (30) more particularly for a window wiping device (1) with an elliptical wiping motion, said device comprising a primary actuating axle (20) intended to be driven in alternate rotation, a rotary support (40) which is made integral with the primary actuating axle (20), a fixed toothed wheel (50) positioned in a coaxial way with respect to the primary actuating axle (20), at least one central toothed wheel (60) supported in axial rotation by the rotary support (40), an output toothed wheel (70), supported in axial rotation by the rotary support (40), and a secondary actuating axle (80) made integral with the output wheel (70), the toothed wheels (50, 60, 70) being engaged with each other and forming a two-stage gear system, characterised in that the rotary support (40) includes two supporting elements (41, 42) that respectively carry the two stages of the gear system and in that the two supporting elements (41, 42) can be arranged in relation to each other following at least two separate angular positions in which the toothed wheels (50, 60, 70) are effectively engaged.

2. A drive mechanism (30) according to claim 1, characterised in that it includes a single central toothed wheel (60) which cooperates, when it is engaged, with the fixed wheel (50) on the one hand and the output wheel on the other hand, respectively, in that one of the supporting elements (41, 42) carries one of the stages of the gear system and in that the other supporting element (41, 42) carries the remaining wheel (50, 70) of the gear system.

3. A drive mechanism (30) according to one of claims 1 or 2, characterised in that both supporting elements (41, 42) are pivotably assembled with respect to each other along an axis collinear to the rotation axis of a central wheel (60), and in that said wiping device (1) further comprises locking means (110) able to lock the relative pivoting between said supporting elements (41, 42).

4. A drive mechanism (30) according to claim 3, characterised in that the locking means (110) include at least one locking element (111, 112, 113) which is able, on the one hand, to get engaged with at least one substantially complementary portion of at least one of the two supporting elements (41, 42) along a direction substantially parallel to the pivoting axis (X) of said supporting elements (41, 42) and on the other hand, to be made integral with at least one of the two supporting elements (41, 42).

5. A drive mechanism (30) according to anyone of claims 1 to 4, characterised in that the two supporting elements (41, 42) are movable with respect to each other and in that said drive mechanism (30) further includes fixing means capable of making integral said supporting elements (41, 42) together.

6. A drive mechanism (30) according to claim 5, characterised in that said fixing means include at least a connection element which is able to be made integral with the two supporting elements (41, 42).

7. A drive mechanism (30) according to claim 6, characterised in that at least one connection is capable of engaging with at least one substantially complementary portion of at least one of the two supporting elements (41, 42) along a direction substantially parallel to the pivoting axis (X) of said supporting elements (41, 42).

8. A drive mechanism (30) according to any one of claims 1 to 7, characterised in that it includes adjusting means capable of precisely positioning both supporting elements (41, 42) with respect to each other along at least two different angular positions where the three toothed wheels (50, 60, 70) are engaged effectively.

9. A drive mechanism (30) according to any one of claims 1 to 8, characterised in that said rotary support (40) forms a casing around the toothed wheels (50, 60, 70) of the gear system.

10. A wiping device (1) with an elliptic wiping motion, comprising motor means (10) capable of generating an alternate rotation motion as well as a wiper arm assembly (90) at the end of which a wiping device (100) is mounted, characterised in that it further comprises a drive mechanism (30) according to anyone of the preceding claims, in that the motor means (10) are coupled to the primary actuating axle (20) and in that the wiper arm assembly (90) is made integral with the secondary actuating axle (80).

11. A motor vehicle characterised in that it includes at least one wiping device having an elliptical wiping motion (1) according to the preceding claim.
